(19) United States
(12) Patent Application Publication
(10) Pub. No.: US 2013/0151937 A1
(43) Pub. Date: Jun. 13, 2013

(54) SELECTIVE IMAGE LOADING IN MOBILE BROWSERS

(71) Applicants: Arnaud Claude WEBER, Saratoga, CA (US); Roma Rajni SHAH, San Francisco, CA (US); Alex Neely AINSLIE, San Francisco, CA (US); Glen MURPHY, Palo Alto, CA (US)

(72) Inventors: Arnaud Claude WEBER, Saratoga, CA (US); Roma Rajni SHAH, San Francisco, CA (US); Alex Neely AINSLIE, San Francisco, CA (US); Glen MURPHY, Palo Alto, CA (US)

(73) Assignee: GOOGLE INC., Mountain View, CA (US)

(21) Appl. No.: 13/315,256

(22) Filed: Dec. 8, 2011

(51) Int. Cl. G06F 17/00

(52) U.S. Cl. 715/207

(57) ABSTRACT

Methods for selectively viewing images in a web page on a mobile device are provided. In one aspect, a method includes receiving a selection from a mobile device to download a web page without downloading images in the web page, and providing the web page with image placeholders in place of the images in the web page, wherein each image placeholder is the same height and width and in the original position of the image in the web page. The method also includes receiving a selection of one or more image placeholders prompting a request to provide and display the one or more corresponding images, and providing the one or more images for display in place of the one or more image placeholders in the web page. Systems, graphical user interfaces, and machine-readable media are also provided.

### BACKGROUND

1. Field

The present disclosure generally relates to the transmission of data over a network, and more particularly to the use of a computing device to communicate over a network.

2. Description of the Related Art

Users browsing the World Wide Web on mobile devices often have limited network connection speeds and/or limits on the amount of data that they can download. As a result, web pages that include images can increase the time and data amount required to download the web pages. A user can, however, choose to not download images for any web page. Unfortunately, resulting web pages can be incorrectly formatted due to missing images, and a user has no recourse to download and view the missing images in a web page should the user change their mind after the web page is downloaded without the images.

### SUMMARY

According to one embodiment of the present disclosure, a computer-implemented method for selectively viewing images in a web page on a mobile device is provided. The method includes receiving a selection from a mobile device to download a web page without downloading images in the web page, and providing the web page with image placeholders in place of the images in the web page, wherein each image placeholder is the same height and width of the image and in the original position of the image in the web page. The method also includes receiving a selection of one or more image placeholders prompting a request to provide and display the one or more corresponding images, and providing the one or more images for display in place of the one or more image placeholders in the web page.

According to another embodiment of the present disclosure, a system for selectively viewing images in a web page on a mobile device is provided. The system includes a memory for storing an identifier of a selection from a mobile device to download a web page without downloading images in the web page, and a processor. The processor is configured to provide, to the mobile device for display in a mobile web browser, the web page with image placeholders in place of the images in the web page, wherein each image placeholder is the same height and width of the image and in the original position of the image in the web page. The processor is also configured to receive a selection of one or more image placeholders prompting a request to provide and display the one or more corresponding images, and provide the one or more images for display in place of the one or more image placeholders in the web page.

According to a further embodiment of the present disclosure, a mobile web browser for selectively viewing images in a web page on a mobile device is provided. The mobile web browser includes a selection interface configured to receive a selection to download a web page to a mobile device without downloading images in the web page, and a display interface configured to display the web page with image placeholders in place of the images in the web page. Each image placeholder is the same height and width of the image and in the original position of the image in the web page. When a selection of one or more image placeholders prompting a request to provide and display the one or more corresponding images is received, the one or more images is displayed in place of the one or more image placeholders in the web page.

According to one embodiment of the present disclosure, a machine-readable storage medium including machine-readable instructions for causing a processor to execute a method for selectively viewing images in a web page on a mobile device is provided. The method includes receiving a selection in a web browser on a mobile device to download a web page to the mobile device without downloading images in the web page, and providing, to the mobile device for display, the web page with image placeholders in place of the images in the web page, wherein each image placeholder is the same height and width of the image, the height and width determined from an image tag of the corresponding image, each image placeholder is in the original position of the image in the web page, and each image placeholder includes text from the metadata of the corresponding image. The method also includes receiving a selection in the web browser of one or more image placeholders prompting a request to provide and display the one or more corresponding images, and providing the one or more images for display in place of the one or more image placeholders in the web page.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an exemplary architecture for selectively viewing images in a web page on a mobile device.

FIG. 2 is a block diagram illustrating the exemplary client and server from the architecture of FIG. 1 according to certain aspects of the disclosure.

FIG. 3 illustrates an exemplary process for selectively viewing images in a web page on a mobile device using an exemplary client of FIG. 2.

FIGS. 4A-4C are exemplary screenshots associated with the exemplary process of FIG. 3.

FIG. 5 is a block diagram illustrating an exemplary computer system with which the client and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed mobile web browser allows a user to select whether to download images for web pages when the user views the web pages on a mobile device. If the user selects to not download images, or to not download images if a network connection is slow, then web pages that are downloaded in the mobile web browser without images show an image placeholder in the appropriate position and with the appropriate height and width of a missing image. The image placeholder can include a display of alternative text encoded in the web page for the missing image. If the user wants to download and view the missing image after the web page is initially downloaded without the image, then the user can click on or press the image placeholder to download and display the missing image in place of the image placeholder.

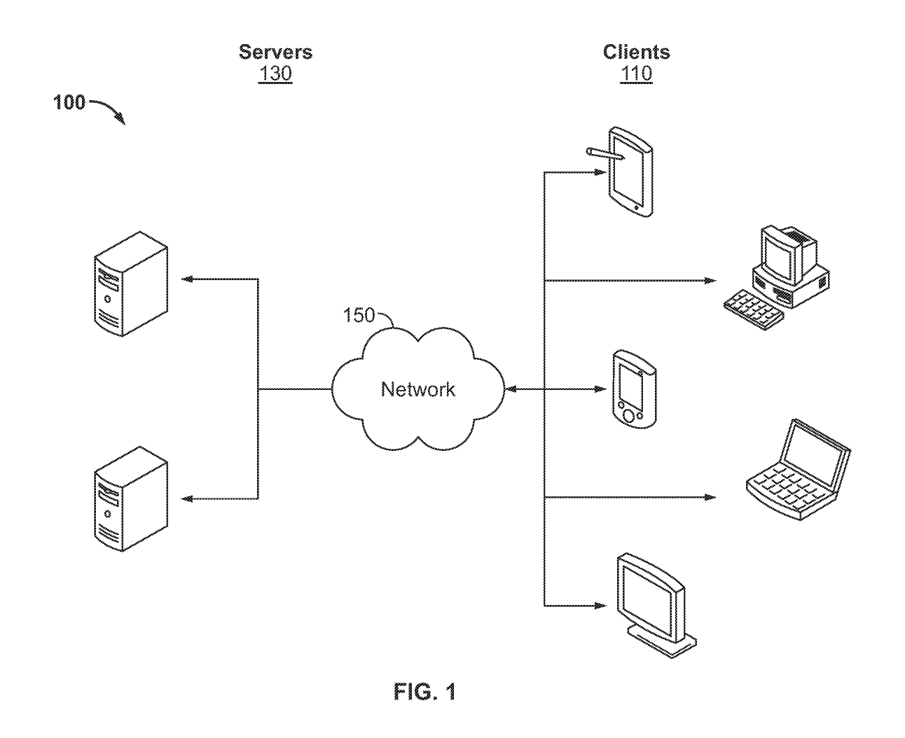

FIG. 1 illustrates an exemplary architecture 100 for selectively viewing images in a web page on a mobile device. The architecture 100 includes servers 130 and clients 110 connected over a network 150.

Each of the clients 130 is configured to download, install, and run a web browser as disclosed herein. The web browser is configured to run on clients 130 that are mobile or non-mobile. The clients 110 can be, for example, desktop computers, laptop computers, mobile devices (e.g., a smartphone, tablet computer, or PDA), set top boxes (e.g., for a television), video game consoles, projectors, or any other devices having appropriate processor, memory, and communications capabilities. In certain aspects, certain advantages of the web browser, such as decreased web page loading time by reducing the amount of data downloaded (e.g., by the data size of images in the web page) are most salient on clients 110 that are mobile devices or that otherwise have slower processing and network data download speeds.

The web browser can be downloaded over the network 150 from one of the many servers 130. For purposes of load balancing, multiple servers 130 can also host the data for downloading the web browser. In certain instances, different versions and/or configurations of the web browser that include the features disclosed herein are available for download from a server 130 and subsequent installation depending on whether the client 110 is a mobile device or non-mobile device. The web browser, once installed on a client 110, is configured to load web pages from any one or multiple servers 130 hosting the web pages. The servers 130 can be any device having an appropriate processor, memory, and communications capability for hosting the data for installing the web browser and for hosting the web pages. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The disclosed web browser, once downloaded from a server 130 and installed and executed on a client 110, is configured to download a web page to the client 110 without downloading images in the web page according to constraints placed by a user. The downloaded web page is displayed by the web browser on the client 110 with image placeholders in place of the images. If a user wants to view an image in the web page, the user can click on the image placeholder, and the web browser will download and display the image on the client 130 as part of the web page.

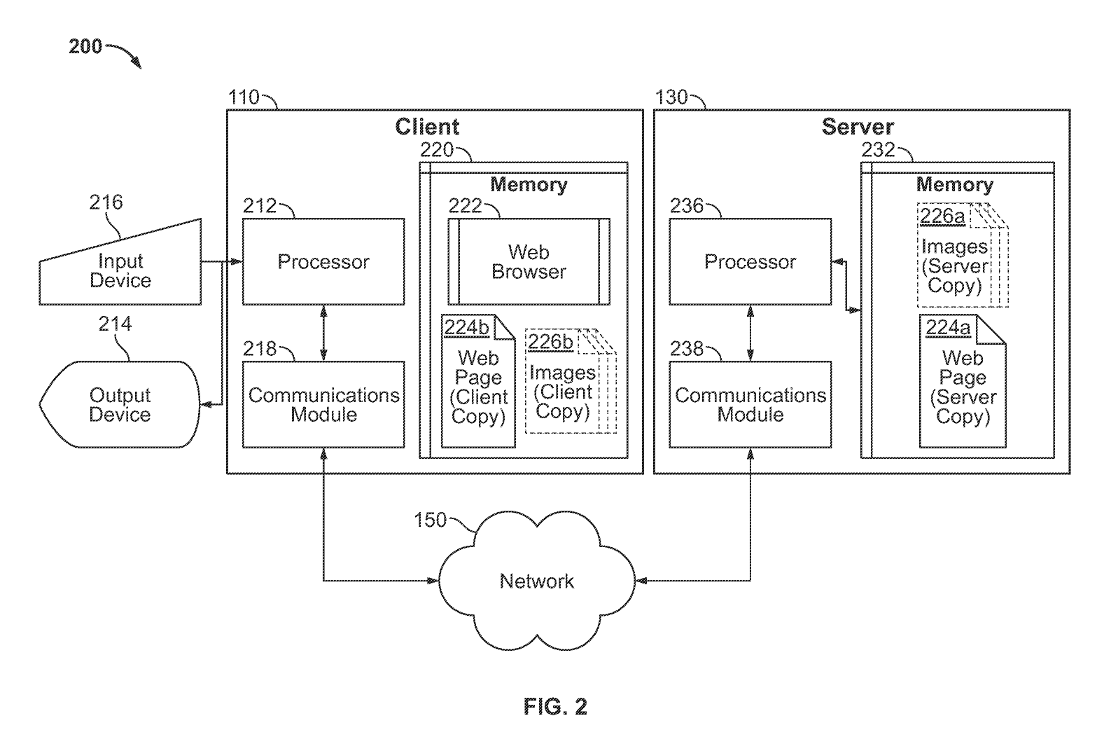

FIG. 2 is a block diagram 200 illustrating an exemplary server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The client 110 includes a processor 212, the communications module 218, and a memory 220. The memory 220 includes a web browser 222 and a client copy of a web page 224b to display in the web browser 222 using the output device 214 (e.g., a display) of the client 110. The client 110 also includes an input device 216, such as a keyboard, touchscreen, or mouse, to receive user requests to download web pages or to set constraints on whether to download images for the web pages. The processor 212 of the client 110 is configured to execute instructions, such as instructions physically coded into the processor 212, instructions received from software in memory 240, or a combination of both. For example, the processor 212 of the client 110 executes instructions from the web browser 222 to receive a selection (e.g., from a user using input device 216) to download a web page 224a from the server 130 without downloading images 226a in the web page 224a. The selection to download the web page 224a without downloading images 226a for the web page 224a can be received within the web browser 222, and can apply to subsequent downloads of web pages within the web browser 222. In certain aspects, the selection can also indicate limiting the download of images 226a to other constraints of the network 150 or the client 110. For example, the selection can indicate downloading the images 226a when the client 110 is connected to a wireless local network (e.g., a Wi-Fi network), but not when the client 110 is connected to a broadband data network. As another example, the selection can indicate downloading the web page 224a without downloading images 226a for the web page 224a when the client device is roaming or otherwise connected to a non-preferred network.

In response to the selection to download the web page 224a without downloading images 226a for the web page 224a, the client 110 sends a request to download the web page 224a from the server 130. The request is sent from the client's communications module 218, over the network 150, to the communications module 238 of the server 130. In certain aspects, the request specifically includes instructions to not download the images 226a in the web page 224a. The server 130 provides a copy of the web page 224a to the client 110 in response to the request, and the client 110 stores a copy of the web page 224b in memory 220.

The processor 212 then provides, for display on the output device 214 of the client 110, the web page 224b in the web browser 222 with image placeholders in place of the images 226a in the web page 224b. Each image placeholder is the same height and width of the image 226a and in the original position of the image 226a that the image placeholder replaces in the web page 224b. The height and width of an image placeholder can be determined from an image tag of the corresponding image 226a (e.g., present in the source code of the web page 224b). In certain aspects, the web browser 222 instructs the processor 212 to generate each image placeholder, and each image placeholder can include text from the metadata of the corresponding image which can be found in the web page 224b (e.g., in the source code of the web page 224b).

When the processor 212 receives a selection (e.g., using the input device 216) of an image placeholder prompting a request to provide and display the corresponding image, a request is sent by the client 110 to the server 130 (or several servers 130 that include copies of the images 226a) to download the corresponding images 226a for the web page 224a from the server 130 (or several servers 130). The selection of the image placeholders can occur by a user selecting a region displayed within the boundaries of the display of the selected image placeholder (e.g., by a user clicking on or in the image placeholder).

In response to the request from the client 100 to the server 130 to download the images 226a corresponding to the selected image placeholders, the server provides the images 226a to the client 110, and the client 110 stores the images 226b in memory 220. FIG. 2 illustrates the images 226b in memory 220 in phantom due to the storage in the memory 220 of the client 110 being contingent on the images 226a being specifically requested for download and display on the client 110. The images 226b are then provided by the processor 212 for display on the output device 214 in place of their corresponding image placeholders in the web page 224b.

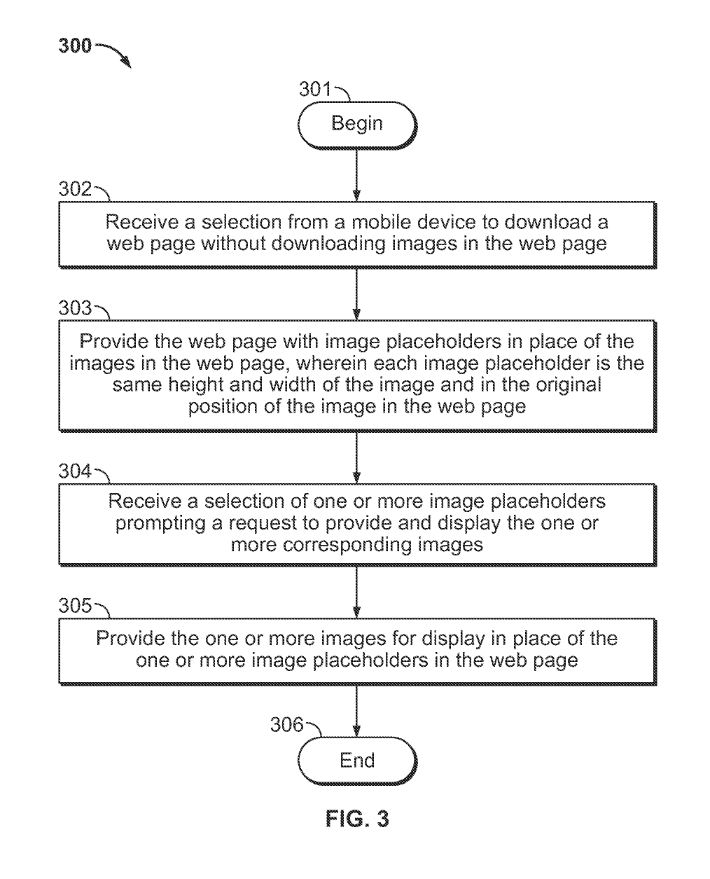

FIG. 3 illustrates an exemplary process 300 for selectively viewing images in a web page 224b on a mobile device using the exemplary client 110 of FIG. 2. The process 300 begins by proceeding from beginning step 301 when a web browser 222 is run on the client 110 to step 302 when a selection is received on the client 110 to download a web page 224a without downloading images 226a in the web page. After receiving a copy of the web page 224a and storing a copy of the web page 224b in memory 220, in step 303 the client 110 provides, for display (e.g., on output device 214), the web page 224b with image placeholders in place of the images 226a in the web page 224b. Each image placeholder is the same height and width of the image 226a and in the original position of the image 226a that the image placeholder replaces in the web page 224b. In step 304, a selection of one or more image placeholders is received, the selection prompting a request to provide and display one or more images 226a corresponding to the selected placeholders. In step 305, after the corresponding images 226a are downloaded from the server 130 and copies of the images 226b are stored in memory 220, the client 110 provides the images 226b for display (e.g., on output device 214) in place of the corresponding image placeholders in the web page 224b, and the process 300 ends.

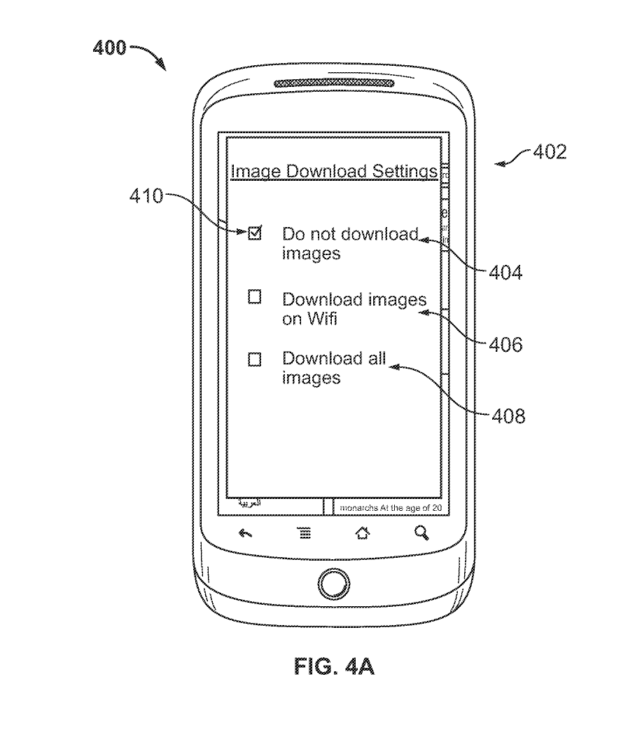

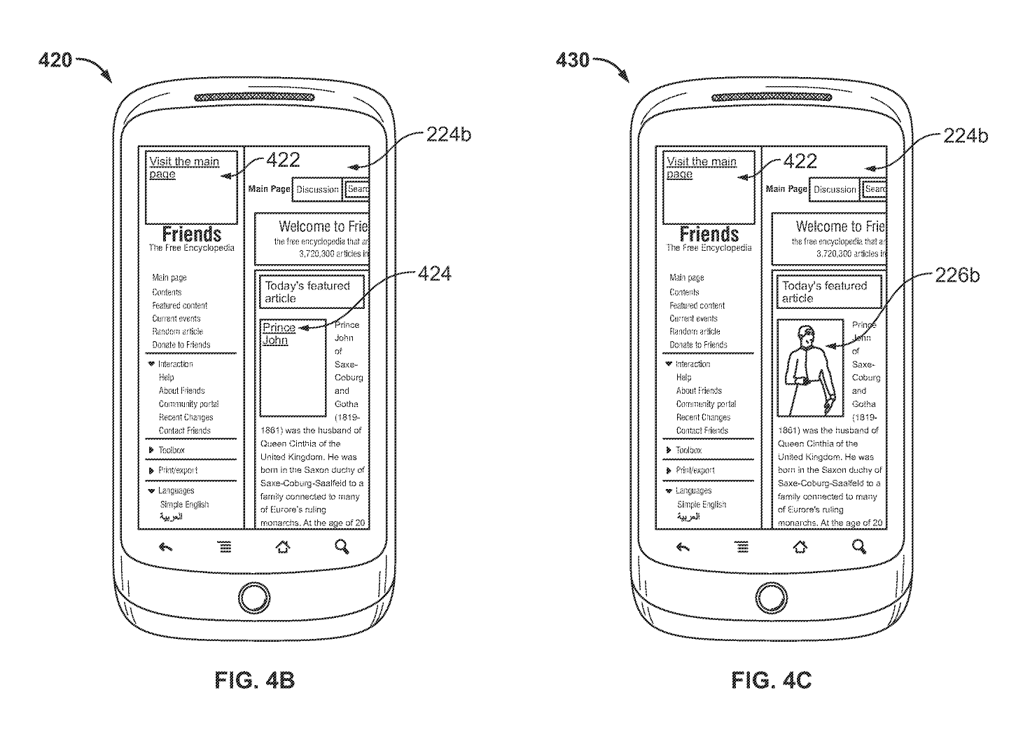

FIG. 3 sets forth an exemplary process 300 for selectively viewing images in a web page 224b on a mobile device using the exemplary client 110 of FIG. 2. An example will now be described using the exemplary process 300 of FIG. 3 and a smartphone as the client 110. The process 300 begins by proceeding from beginning step 301 when a web browser 222 is run on the client 110 to step 302 when a user selects to download web pages 224a in the web browser 222 without downloading images 226a in the web pages. FIG. 4A illustrates an exemplary screenshot 400 of a selection interface 402 in which the user has selected 410 the option 404 of downloading web pages 224a without downloading images 226a in the web pages in the web browser 222. The selection interface also includes an alternative option 406 for downloading images 226a for web pages 224a when the smartphone 110 is connected to a Wi-Fi network, and another alternative option 408 of downloading images 226a for web pages 224a. After receiving the user's selection, the smartphone 110 proceeds to download a copy of a web page 224a from a server 130.

After receiving a copy of the web page 224a and storing a copy of the web page 224b in memory 220, in step 303 the smartphone 110 displays a copy of the web page 224b as illustrated in FIG. 4B. FIG. 4B is an exemplary screenshot 420 of a web page 224b downloaded by a web browser 222 on the smartphone 110 when the web browser 222 is configured to download web pages without downloading images in the web pages. The exemplary screenshot 420 displays, in a display interface of the web browser 222, a web page 224b with image placeholders 422 and 424 in place of images in the web page 224b. Each image placeholder is the same height and width of the image 226a and in the original position of the image 226a that the image placeholder replaces in the web page 224b.

In step 304, the user touches (e.g., using a touch input) the image placeholder 424 for an image of Prince Albert. In step 305, the smartphone 110 downloads the corresponding image 226a from the server 130, stores a copy of the image 226b in memory 220, and provides the image 226b for display, as illustrated in FIG. 4C. FIG. 4C is an exemplary screenshot 430 of the web page 224b of FIG. 4B after the selected image 226b has been downloaded and displayed in place of its corresponding image placeholder 424. The process 300 ends.

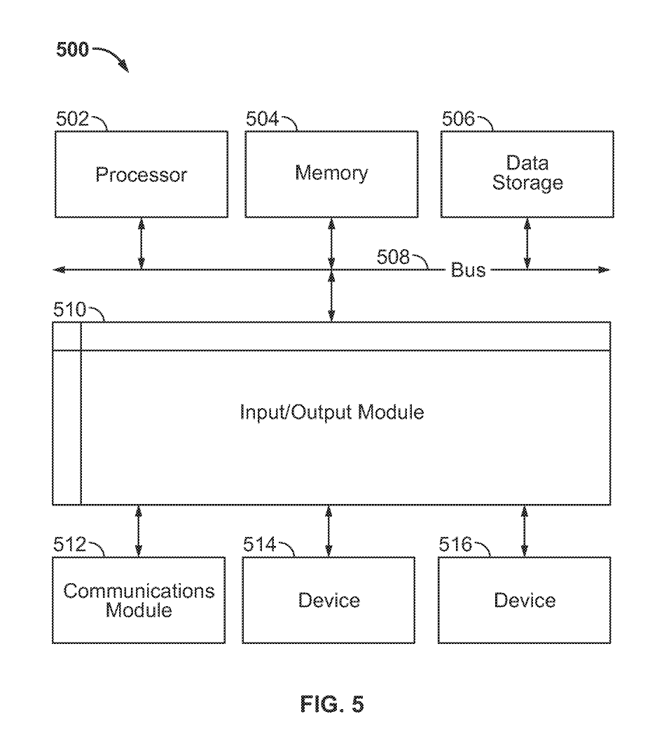

FIG. 5 is a block diagram illustrating an exemplary computer system 500 with which the client 110 and server 130 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110 and server 130) includes a bus 508 or other communication mechanism for communicating information, and a processor 502 (e.g., processor 212 and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 (e.g., communications modules 218 and 238) include networking interface cards, such as Ethernet cards and modems. In certain aspects, the input/output module 510 is configured to connect to a plurality of devices, such as an input device 514 (e.g., input device 216) and/or an output device 516 (e.g., output device 214). Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 516 include display devices, such as a CRT (cathode ray tube) or LCD (liquid crystal display) monitor, for displaying information to the user.

According to one aspect of the present disclosure, the client 110 and server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A computer-implemented method for selectively viewing images in a web page on a mobile device, the method comprising:
receiving, prior to a mobile device beginning download of a web page in a web browser, a selection on the mobile device to download web pages without downloading images in the web page;
storing, in a memory of the mobile device, the selection to download web pages without downloading images in the web page;
inserting, by the web browser, image placeholders in place of the images in the web page, wherein each image placeholder is the same height and width of the image and in the original position of the image in the web page;
providing, by the web browser, the web page for display with the image placeholders in place of the images in the web page;
receiving a selection of one or more image placeholders indicating a request to provide for display the one or more corresponding images; and
providing the one or more corresponding images for display in place of the one or more image placeholders in the web page.

2. (canceled)

3. The computer-implemented method of claim 1, wherein the selection to download web pages without downloading images is applied to subsequent downloads of web pages within the web browser.

4. The computer-implemented method of claim 1, wherein the web browser generates each image placeholder.

5. The computer-implemented method of claim 1, wherein each image placeholder comprises text from the metadata of the corresponding image.

6. The computer-implemented method of claim 1, wherein the height and width of an image placeholder is determined from an image tag of the corresponding image.

7. The computer-implemented method of claim 1, wherein, based on the received selection to download web pages without downloading images in the web page, the mobile device sends a request to a server to download the web page to the mobile device, the request excluding a request to download the images in the web page.

8. The computer-implemented method of claim 1, wherein the selection of the one or more of image placeholders indicating the request to provide for display the one or more corresponding images is received in a region displayed within the boundaries of the selected one or more image placeholders displayed on the mobile device.

9. The computer-implemented method of claim 1, wherein, in response to receiving the selection of the one or more of image placeholders indicating the request to provide and display the one or more corresponding images, the mobile device sends a request to download the one or more corresponding images to one or more servers comprising a copy of the one or more corresponding images.

10. A system for selectively viewing images in a web page on a mobile device, the system comprising:
a memory for storing on a mobile device an identifier of a selection made in a web browser on the mobile device prior to the mobile device beginning download of a web page, wherein the selection is to download web pages without downloading images in the web page;
a processor configured to:
insert, by the web browser and based on the stored identifier of the selection to download web pages without downloading images in the web page and for display in a mobile web browser, image placeholders in place of the images in the web page, wherein each image placeholder is the same height and width of the image and in the original position of the image in the web page;
provide the web page with the image placeholders in place of the images in the web page;
receive a selection of one or more image placeholders indicating a request to provide for display the one or more corresponding images; and
provide the one or more corresponding images for display in place of the one or more image placeholders in the web page.

11. (canceled)

12. The system of claim 10, wherein the selection to download web pages without downloading images is applied to subsequent downloads of web pages within the web browser.

13. The system of claim 10, wherein the web browser generates each image placeholder.

14. The system of claim 10, wherein each image placeholder comprises text from the metadata of the corresponding image.

15. The system of claim 10, wherein the height and width of an image placeholder is determined from an image tag of the corresponding image.

16. The system of claim 10, wherein, based on the received selection to download web pages without downloading images in the web page, the processor is configured to send a request to a server to download the web page to the mobile device, the request excluding a request to download the images in the web page.

17. The system of claim 10, wherein the selection of the one or more of image placeholders indicating the request to provide for display the one or more corresponding images is received in a region displayed within the boundaries of the selected one or more image placeholders displayed on the mobile device.

18. The system of claim 10, wherein, in response to receiving the selection of the one or more of image placeholders indicating the request to provide for display the one or more corresponding images, the processor is configured to send a request to download the one or more corresponding images to one or more servers comprising a copy of the one or more corresponding images.

19. A mobile device comprising:
a processor; and
a memory comprising:
a selection interface configured to receive, prior to a mobile device beginning download of a web page, a selection to download web pages to the mobile device without downloading images in the web page, wherein the selection to download web pages without downloading images in the web page is stored in the memory of the mobile device; and
a display interface configured to insert, by the web browser, image placeholders in place of the images in the web page, wherein each image placeholder is the same height and width of the image and in the original position of the image in the web page, display, using the processor, the web page with the image placeholders in place of the images in the web page, and receive a selection of one or more image placeholders indicating a request to provide for display the one or more corresponding images,
wherein, when the selection of the one or more image placeholders is received, the one or more corresponding images is displayed in place of the one or more image placeholders in the web page.

20. A machine-readable storage medium comprising machine-readable instructions for causing a processor to execute a method for selectively viewing images in a web page on a mobile device, the method comprising:
receiving, prior to a mobile device beginning download of a web page, a selection in a web browser on the mobile device to download web pages to the mobile device without downloading images in the web page;
storing, in a memory of the mobile device, the selection to download web pages without downloading images in the web page;
inserting, by the web browser, image placeholders in place of the images in the web page, wherein each image placeholder is the same height and width of the image, the height and width of the image placeholder determined from an image tag of the corresponding image, each image placeholder is in the original position of the image in the web page, and each image placeholder comprises text from metadata of the corresponding image;
providing, to the mobile device for display, the web page with the image placeholders in place of the images in the web page;
receiving a selection in the web browser of one or more image placeholders indicating a request to provide for display the one or more corresponding images; and
providing the one or more corresponding images for display in place of the one or more image placeholders in the web page.
